(19) United States
(12) Patent Application Publication
(10) Pub. No.: US 2018/0067214 A1
(43) Pub. Date: Mar. 8, 2018

(54) CARRIER-PHASE SMOOTHING OF CODE-PHASE MEASUREMENTS

(71) Applicant: QUALCOMM Incorporated, San Diego, CA (US)

(72) Inventors: Urs NIESEN, Summit, NJ (US); Lionel Jacques GARIN, Palo Alto, CA (US); Jubin JOSE, Belle Mead, NJ (US)

(21) Appl. No.: 15/258,301

(22) Filed: Sep. 7, 2016

(51) Int. Cl. G01S 19/43; G01S 19/29; G01S 19/30

(52) U.S. Cl. CPC G01S 19/43; G01S 19/30; G01S 19/29

(57) ABSTRACT

An example of a method of determining a position of a device includes: receiving, with a receiver of the device, a signal from a reference emitter; obtaining a code phase measurement of the signal; obtaining a carrier phase measurement of the signal; calculating an intermediate quantity that is a function of the code phase measurement and the carrier phase measurement; calculating a carrier phase smoothed estimate of a code phase of the signal based, at least in part, on a robust aggregation of the intermediate quantity; and determining the position of the device based, at least in part, on the carrier phase smoothed estimate of the code phase.

### BACKGROUND

Satellite positioning systems (SPSs) broadcast positioning signals from a constellation of satellites that can be used by a device with an SPS receiver to determine the position and/or velocity of the device. Example SPS include Global Positioning System (GPS), Global Navigation Satellite System (GNSS), Galileo, GLONASS, Beidou (Compass), etc. Each satellite in an SPS broadcasts signals using at least one carrier frequency. For example, GPS uses two carrier frequencies: 1575.4 MHz and 1227.6 MHz. Other SPSs may use more than two carrier frequencies or just one carrier frequency.

Signals broadcast from an SPS satellite are conventionally modulated with a pseudo-random code (PRC). The PRC may also be referred to as a spreading code because it spreads the frequency spectrum of the signal over a particular range of frequencies (e.g., 1 MHz bandwidth). An SPS receiver receives the signal from the SPS satellite and determines the time of arrival (TOA) of the signal by correlating the received signal with a locally generated PRC. In this way, the distance between the SPS receiver and the satellite can be determined by, for example, determining the transit time of the signal (the difference in time between when the signal was received and when the satellite transmitted the signal) and multiplying that transit time by the speed of light. The distance between the satellite and the receiver is referred to as the pseudorange or a code phase measurement. Due to the limited bandwidth of the PRC (e.g., 1 MHz) and noise, the accuracy of the pseudorange measurement is on the order of one meter. However, if a carrier phase measurement is performed and used to determine the location of the receiver, the accuracy of the location of the receiver can be increased.

### SUMMARY

An example of a method of determining a position of a device includes: receiving, with a receiver of the device, a signal from a reference emitter; obtaining a code phase measurement of the signal; obtaining a carrier phase measurement of the signal; calculating an intermediate quantity that is a function of the code phase measurement and the carrier phase measurement; calculating a carrier phase smoothed estimate of a code phase of the signal based, at least in part, on a robust aggregation of the intermediate quantity; and determining the position of the device based, at least in part, on the carrier phase smoothed estimate of the code phase.

Implementations of such a method may include one or more of the following features. The intermediate quantity may include a difference between the code phase measurement and the carrier phase measurement. The robust aggregation of the intermediate quantity may be a median value of the intermediate quantity. The method may further include determining the median value of the intermediate quantity using a min heap data structure and a max heap data structure. A minimum value of the min heap data structure may be greater than or equal to a maximum value of the max heap data structure, and a number of values of the min heap data structure and a number of values of the max heap data structure differs by no more than one. Determining the median value of the intermediate quantity may include inserting the intermediate quantity into the min heap data structure in response to a determination that the intermediate quantity is greater than the minimum value of the min heap data structure; and inserting the intermediate quantity into the max heap data structure in response to a determination that the intermediate quantity is less than the maximum value of the max heap data structure. The method may further include removing the minimum value from the min heap data structure and inserting the minimum value into the max heap data structure in response to a determination that the number of values of the min heap data structure is greater than the number of values of the max heap data structure by more than one; and removing the maximum value from the max heap data structure and inserting the maximum value into the min heap data structure in response to a determination that the number of values of the max heap data structure is greater than the number of values of the min heap data structure by more than one. The method may further include setting the median value of the intermediate quantity equal to the maximum value of the max heap data structure in response to a determination that the number of values of the max heap data structure is greater than the number of values of the min heap data structure; setting the median value of the intermediate quantity equal to the minimum value of the min heap data structure in response to a determination that the number of values of min heap data structure is greater than the number of values of the max heap data structure; and setting the median value of the intermediate quantity equal to a mean value of the maximum value of the max heap data structure and the minimum value of the min heap data structure in response to a determination that the number of values of the max heap data structure is equal to the number of values of the min heap data structure. Calculating the carrier phase smoothed estimate of the code phase of the signal may include adding the carrier phase measurement to the robust aggregation of the intermediate quantity.

An example of a device for determining a position of the device includes: a wireless receiver for wirelessly receiving a signal from a reference emitter; and a processor, communicatively coupled to the wireless receiver, configured to: obtain a code phase measurement of the signal; obtain a carrier phase measurement of the signal; calculate an intermediate quantity that is a function of the code phase measurement and the carrier phase measurement; calculate a carrier phase smoothed estimate of a code phase of the signal based, at least in part, on a robust aggregation of the intermediate quantity; and determine the position of the device based, at least in part, on the carrier phase smoothed estimate of the code phase.

Implementations of such a device may include one or more of the following features. The intermediate quantity may include a difference between the code phase measurement and the carrier phase measurement. The processor may be configured to determine the robust aggregation of the intermediate quantity by determining a median value of the intermediate quantity. The device may further include a memory configured to store a min heap data structure and a max heap data structure. The processor may be further configured to determine the median value of the intermediate quantity using the min heap data structure and the max heap data structure. A minimum value of the min heap data structure may be greater than or equal to a maximum value of the max heap data structure, and a number of values of the min heap data structure and a number of values of the max heap data structure differs by no more than one. The processor may be further configured to determine the median value of the intermediate quantity by: inserting the intermediate quantity into the min heap data structure in response to a determination that the intermediate quantity is greater than the minimum value of the min heap data structure; and inserting the intermediate quantity into the max heap data structure in response to a determination that the intermediate quantity is less than the maximum value of the max heap data structure. The processor may be further configured to: remove the minimum value from the min heap data structure and insert the minimum value into the max heap data structure in response to a determination that the number of values of the min heap data structure is greater than the number of values of the max heap data structure by more than one; and remove the maximum value from the max heap data structure and insert the maximum value into the min heap data structure in response to a determination that the number of values of the max heap data structure is greater than the number of values of the min heap data structure by more than one. The processor may be further configured to: set the median value of the intermediate quantity equal to the maximum value of the max heap data structure in response to a determination that the number of values of the max heap data structure is greater than the number of values of the min heap data structure; set the median value of the intermediate quantity equal to the minimum value of the min heap data structure in response to a determination that the number of values of the min heap data structure is greater than the number of values of the max heap data structure; and set the median value of the intermediate quantity equal to a mean value of the maximum value of the max heap data structure and the minimum value of the min heap data structure in response to a determination that the number of values of the max heap data structure is equal to the number of values of the min heap data structure. The processor may be further configured to calculate the carrier phase smoothed estimate of the code phase of the signal by adding the carrier phase measurement to the robust aggregation of the intermediate quantity.

An example of a device for determining a position of the device includes receiving means for wirelessly receiving a signal from a reference emitter; and first obtaining means for obtaining a code phase measurement of the signal; second obtaining means for obtaining a carrier phase measurement of the signal; calculating means for calculating an intermediate quantity that is a function of the code phase measurement and the carrier phase measurement; smoothing means for calculating a carrier phase smoothed estimate of a code phase of the signal based, at least in part, on a robust aggregation of the intermediate quantity; and positioning means for determining the position of the device based, at least in part, on the carrier phase smoothed estimate of the code phase.

Implementations of such a device may include one or more of the following features. The intermediate quantity may include a difference between the code phase measurement and the carrier phase measurement. The robust aggregation of the intermediate quantity may be a median value of the intermediate quantity. The device may further include: storing means for storing a min heap data structure and a max heap data structure; and determining means for determining the median value of the intermediate quantity using the min heap data structure and the max heap data structure, wherein a minimum value of the min heap data structure is greater than or equal to a maximum value of the max heap data structure, and wherein a number of values of the min heap data structure and a number of values of the max heap data structure differs by no more than one. The determining means may include: first inserting means for inserting the intermediate quantity into the min heap data structure in response to a determination that the intermediate quantity is greater than the minimum value of the min heap data structure; and second inserting means for inserting the intermediate quantity into the max heap data structure in response to a determination that the intermediate quantity is less than the maximum value of the max heap data structure. The determining means may further be for: removing the minimum value from the min heap data structure and inserting the minimum value into the max heap data structure in response to a determination that the number of values of the min heap data structure is greater than the number of values of the max heap data structure by more than one; and removing the maximum value from the max heap data structure and inserting the maximum value into the min heap data structure in response to a determination that the number of values of the max heap data structure is greater than the number of values of the min heap data structure by more than one. The determining means may further be for: setting the median value of the intermediate quantity equal to the maximum value of the max heap data structure in response to a determination that the number of values of the max heap data structure is larger than the number of values of the min heap data structure; setting the median value of the intermediate quantity equal to the minimum value of the min heap data structure in response to a determination that the number of values of min heap data structure is larger than the number of values of the max heap data structure; and setting the median value of the intermediate quantity equal to a mean value of the maximum value of the max heap data structure and the minimum value of the min heap data structure in response to a determination that the number of values of the max heap data structure is equal to the number of values of the min heap data structure. The smoothing means may further be for adding the carrier phase measurement to the robust aggregation of the intermediate quantity.

An example of a non-transitory processor-readable storage medium includes processor-readable instructions configured to cause a processor of a device to: receive a signal from a reference emitter; obtain a code phase measurement of the signal; obtain a carrier phase measurement of the signal; calculate an intermediate quantity that is a function of the code phase measurement and the carrier phase measurement; calculate a carrier phase smoothed estimate of a code phase of the signal based, at least in part, on a robust aggregation of the intermediate quantity; and determine the position of the device based, at least in part, on the carrier phase smoothed estimate of the code phase.

Implementations of such a non-transitory processor-readable storage medium may include one or more of the following features. The intermediate quantity may include a difference between the code phase measurement and the carrier phase measurement; and the instructions configured to cause the processor to calculate the carrier phase smoothed estimate of the code phase of the signal may include instructions configured to add the carrier phase measurement to the robust aggregation of the intermediate quantity. The robust aggregation of the intermediate quantity may be a median value of the intermediate quantity. The non-transitory processor-readable storage medium may further include instructions configured to cause the processor to determine the median value of the intermediate quantity using a min heap data structure and a max heap data structure, wherein a minimum value of the min heap data structure is greater than or equal to a maximum value of the max heap data structure, and wherein a number of values of the min heap data structure and a number of values of the max heap data structure differs by no more than one. The instructions configured to cause the processor to determine the median value of the intermediate quantity may include instructions configured to cause the processor to: insert the intermediate quantity into the min heap data structure in response to a determination that the intermediate quantity is greater than the minimum value of the min heap data structure; and insert the intermediate quantity into the max heap data structure in response to a determination that the intermediate quantity is less than the maximum value of the max heap data structure. The instructions configured to cause the processor to determine a median value of the intermediate quantity may further include instructions configured to cause the processor to: remove the minimum value from the min heap data structure and insert the minimum value into the max heap data structure in response to a determination that the number of values of the min heap data structure is greater than the number of values of the max heap data structure by more than one; and remove the maximum value from the max heap data structure and insert the maximum value into the min heap data structure in response to a determination that the number of values of the max heap data structure is greater than the number of values of the min heap data structure by more than one. The instructions configured to cause the processor to determine the median value of the intermediate quantity may include instructions configured to cause the processor to: set the median value of the intermediate quantity equal to the maximum value of the max heap data structure in response to a determination that the number of values of the max heap data structure is greater than the number of values of the min heap data structure; set the median value of the intermediate quantity equal to the minimum value of the min heap data structure in response to a determination that the number of values of min heap data structure is greater than the number of values of the max heap data structure; and set the median value of the intermediate quantity equal to the mean value of the maximum value of the max heap data structure and the minimum value of the min heap data structure in response to a determination that the number of values of the max heap data structure is equal to the number of values of the min heap data structure.

Items and/or techniques described herein may provide fast and robust smoothing of a code phase measurement of a signal using the carrier phase measurement of the signal, as well as other capabilities not mentioned. Additionally, techniques described herein may provide faster access to high precision positioning solutions. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

Non-limiting and non-exhaustive examples of methods and systems are described with reference to the following figures. The figures may not be drawn to scale.

FIG. 1 is a simplified diagram of an example of a satellite positioning system.

FIG. 2 is a block diagram of an example of a device that may be a part of the satellite positioning system of FIG. 1

FIG. 3 is a flow diagram of an example method of determine the position of the device of FIG. 2.

FIG. 4 is a flow diagram of an example method of calculating a carrier phase smoothed estimate of a code phase operating the device of FIG. 2.

### DETAILED DESCRIPTION

Techniques are discussed herein for fast and robust carrier-phase smoothing of code-phase measurements in a satellite positioning system (SPS). In general, SPS receivers make two types of measurements for each signal received from a satellite of the SPS: code phase measurements and carrier phase measurements. The code phase measurements typically have a noise standard deviation on the order of 1-2 meters. The carrier phase measurements, however, may be much more precise with a noise standard deviation on the order of 1-2 centimeters. The carrier phase measurements can be used to average noise in the code phase measurements in a process known as “smoothing.” The reduced noise code-phase measurement is referred to as a carrier-phase smoothed code phase measurement.

Carrier-phase smoothing of the code-phase measurements using a simple averaging technique is susceptible to erroneous results due to outlier measurements. For example, a single, large outlier measurement may completely corrupt the carrier-phase smoothed code phase measurement. Outlier measurements become particularly problematic in urban environments where many phase measurements made by the receiver can be outliers.

A robust aggregation approach as described herein allows for fast smoothing of the code-phase measurements of the received signals while being less susceptible to outlier measurements as compared to a simple averaging technique. In an example, a carrier phase measurement and a code phase measurement of a signal may be used to calculate an intermediate quantity. For each epoch of the SPS, the phase measurements are made and the intermediate quantity is calculated. The intermediate quantity may be, for example, the difference between the code phase measurement and the carrier phase measurement. A robust aggregation of the intermediate quantity for a current time and multiple previous times is determined. The robust aggregation may be a median value of the intermediate quantities. The carrier phase measurement is added to the robust aggregation value to yield the carrier-phase smoothed code-phase measurement for the current time. This method can be repeated for every epoch of the SPS.

In an example, the median value of the intermediate quantity can be determined using a min heap data structure and a max heap data structure. The two heap data structures are maintained such that the size of the min heap data structure (i.e., the number of values in the min heap data structure) and the size of the max heap data structure (i.e., the number of values in the max heap data structure) differ by no more than one. Additionally, the two heap data structures are maintained such that the minimum value of the min heap data structure is greater than or equal to the maximum value of the max heap data structure.

Using a median value of the intermediate quantity to produce the carrier-phase smoothed code phase measurement allows for a robust code phase measurement that is less susceptible to outlier phase measurements than other aggregation techniques. Moreover, using a min heap data structure and a max heap data structure to determine the median allows the median to be calculated quickly and efficiently. In particular, finding the minimum and/or maximum value of a heap data structure can be performed in constant time and inserting and/or removing an element into a heap data structure can be performed in a time that is logarithmic in the size of the heap.

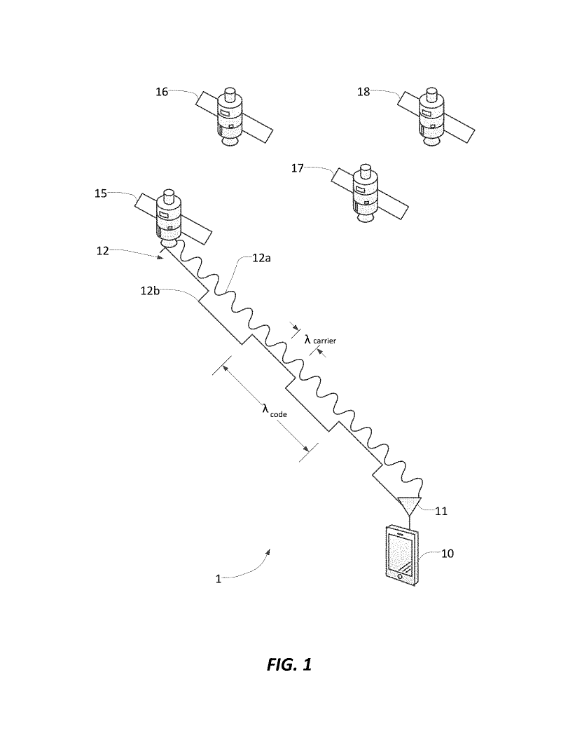

Referring to FIG. 1, a simplified diagram of an example of a satellite position system (SPS) is shown. An SPS 1 includes a device 10 and a constellation of four satellites 15-18. The device 10 includes an antenna 11. Each of the satellites 15-18 emits a signal that is received by the antenna 11 and used by the device 10 to determine the position of the device based on the time of arrivals of the signals. For the sake of clarity, FIG. 1 illustrates only a single signal 12 emitted by satellite 15. However, while not shown in FIG. 1, the satellites 16-18 emit signals similar to the signal 12 and can be received by the device 10. Additionally, the constellation of satellites may include more than the four satellites 15-18.

The signal 12, for purposes of illustrating the carrier phase and code phase, is illustrated as two separate signals: a carrier signal 12a and a code signal 12b. The carrier signal 12a has a wavelength λ_{carrier} and the code signal 12b has a wavelength λ_{code}, which is greater than the wavelength λ_{carrier}. While not illustrated in detail in FIG. 1, the code signal 12b is a pseudo-random code (PRC) signal that repeats with a frequency that corresponds to the wavelength λ_{code}.

The device 10 includes an SPS receiver that is operably coupled to the antenna 11 and includes a carrier phase tracking loop for monitoring the carrier phase of the signal 12 and a delay tracking loop for monitoring the code phase of the signal. The code phase measurement is a determination of how many periods of the code signal 12b occur between the satellite 15 and the antenna 11, and the carrier phase measurement is a determination of how many periods of the carrier phase signal 12a occur between the satellite 15 and the antenna 11. Because the wavelength λ_{code}, is greater than the wavelength λ_{carrier}, the carrier phase measurement can be used to smooth the code phase measurement and provide more reliable measurement results. Techniques described herein allow the device 10 to quickly and robustly perform carrier-phase smoothing of the code phase measurement.

The device 10 not only makes phase measurements for multiple satellites, but it makes multiple phase measurements over time, which may be stored in a memory of the device 10. For a particular satellite the code phase measurement is represented by ρ(t) and the carrier phase measurement is represented by φ(t). These two phase measurements are associated with a time which corresponds to a particular epoch of the SPS. An estimate for the code phase at time t, can be made using the carrier phase measurement and past measurements of the code phase and the carrier phase. Each code phase measurement is calculated by the formula:

\hat{ρ}_{τ}(t)=ρ(t−τ)−φ(t−τ)+φ(t),

where \hat{ρ}_{τ}(t) is the code phase estimate at time t based on past measurements made at time t−τ, ρ(t−τ) is the code phase measurement at time t−τ, φ(t−τ) is the carrier phase measurement at time t−τ, and φ(t) is the carrier phase measurement at time t. These estimates can be determined for every from 0 to T−1, where T is the number of past and present phase measurements available in memory.

A carrier-phase smoothed code-phase measurement, ρ̅(t), is determined by taking the median of the multiple code phase measurements, \hat{ρ}_{τ}(t), as shown by the formula:

ρ̅(t)=median{\hat{ρ}_{τ}(t)}_{τ=0}^{T-1}.

All of the past measurements available in memory may be used in calculating the median, or the device 10 may use only a certain number of phase measurements that are less than a threshold amount of time away. For example, the device may have T measurements stored in memory but only use the most recent T′ measurements, where T′<T.

While examples described herein utilize a median of the code phase estimates to determine the carrier-phase smoothed code-phase measurement, other robust aggregations may be used. Examples of robust aggregation techniques that may be used include a trimmed (truncated) mean, a winsorized mean, or an M-estimator using a Huber loss function or a Tukey bisquare loss function.

To determine the median of the code phase measurements, the device 10 may instead determine the median of an intermediate quantity that is a function, ƒ(t), of the code phase measurement and the carrier phase measurement at a particular time t. For example, the difference of the code phase measurement and the carrier phase measurement, ƒ(t−τ)=ρ(t−τ)−φ(t−τ), may be used. The device may determine the median of the past values of this intermediate quantity, represented by the formula:

ƒ̅(t)=median{ƒ(t−τ)}_{τ=0}^{τ=T-1}.

The carrier phase measurement at time t is added to the median value to determine the quantity that is used as the carrier-phase smoothed code phase estimate, as represented by the formula:

ρ̅(t)=ƒ̅(t)+φ(t).

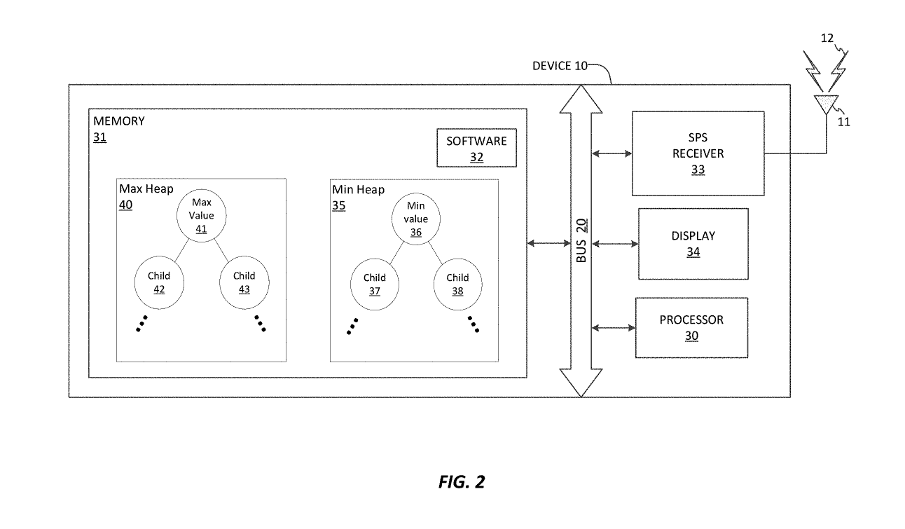

Referring to FIG. 2, a block diagram of an example of a device 10 that may be part of a satellite position system is shown. The device 10 is a computer system that includes the antenna 11, a processor 30, a memory 31, an SPS receiver 33, and a display 34. The device 10 may be a handheld mobile device, such as a mobile phone or smart phone, or a navigation device used by an individual or a vehicle, such as an automobile, boat, or airplane. In the cases where the device 10 is a mobile device, the device 10 includes one or more transceivers (not shown) for communicating with a cellular communication network by transmitting wireless signals to cellular base stations, such as wireless base transceiver stations (BTS), Node Bs, evolved NodeBs (eNB), etc. Similarly, device 10 may include other wireless transceivers (not shown) for transmitting wireless signals to and receiving wireless signals from local transceivers such as Wi-Fi access points (AP), femtocells, Home Base Stations, small cell base stations, Home Node Bs (HNB) or Home eNodeBs (HeNB) and may provide access to a wireless local area network (WLAN, e.g., IEEE 802.11 network), a wireless personal area network (WPAN, e.g., Bluetooth® network or ZigBee® network) or a cellular network (e.g. an LTE network or other wireless wide area network such as those discussed in the next paragraph).

The antenna 11 receives the wireless signal 12 from the satellite 15, as well as the signals emitted by the other satellites 16-18 in the SPS 1. The SPS receiver 33 is a wireless receiver for receiving the signal 12 from the satellite 15 via the antenna 11. The SPS receiver 33 includes the necessary systems (not shown) for measuring the code phase and carrier phase of the signal 12, such as a delay lock loop and a phase lock loop. The SPS 1 may be a Global Positioning System (GPS), Global Navigation Satellite System (GNSS), Galileo, GLONASS, Beidou (Compass), etc. While examples of SPSs discussed herein are described as being based on satellite based systems, the satellites 15-18 are one example of a reference emitter that may emit a positioning signal. Other examples of reference emitters include space vehicles that are not in orbit, various aircraft, or ground based emitters, such as cellular network base stations.

The processor 30 is an intelligent device, e.g., a central processing unit (CPU) such as those made or designed by Qualcomm®, ARM®, Intel® Corporation, or AMD®, a microcontroller, an application specific integrated circuit (ASIC), etc. The memory 31 is non-transitory, processor-readable memory that stores instructions that may be executed by processor 30 and includes random access memory (RAM), read-only memory (ROM) and non-volatile memory such as flash memory or solid state storage. The display 34 may be a liquid-crystal display (LCD) (e.g., a thin-film transistor (TFT) display), although other forms of displays are acceptable. The display 34 displays location information to a user of the device by, for example, displaying coordinates and/or a graphical representation of the position of the device 10 on a map. Software 32 can be loaded onto the memory 31 by being downloaded via a network connection, uploaded from a disk, etc. Further, the software 32 may not be directly executable, e.g., requiring compiling before execution. The software 32 includes instructions configured to cause the processor 30 to perform functions described below. The various components of the mobile device 10 are communicatively coupled to one another via bus 20. While FIG. 2 illustrates the processor 30 and the memory 31 being separate from the SPS receiver 33, the processor 30 and memory 31 may be components of the SPS receiver 33 such that the processing of the SPS signal is performed by the SPS receiver.

The processor 30 is communicatively coupled to both the SPS receiver 33 and the memory 31 via the bus 20. The processor 30 is configured to obtain the signal 12 and/or the code and carrier phase measurements from the SPS receiver and determine the location of the device 10 from the signal 12 and the other signals received from the other satellites 16-18 of the SPS constellation.

The processor 30 is configured to obtain a code phase measurement and a carrier phase measurement of the signal. Obtaining these measurements may include receiving the measurements from the SPS receiver 33 via the bus 20 or receiving the measurement from memory 31 via the bus 20.

The processor 30 is configured to calculate an intermediate quantity that is a function of the code phase measurement and the carrier phase measurement. The function may be the difference of the code phase measurement and the carrier phase measurement. This intermediate quantity may be determined for every epoch of the SPS and stored in memory 31. Every past calculation result of the intermediate quantity may be stored in memory or only a set number of past calculation results may be stored.

The processor 30 is configured to calculate a carrier phase smoothed estimate of a code phase of the signal based, at least in part, on a robust aggregation of the intermediate quantity. As mentioned above, examples of a robust aggregation include a median, a trimmed (truncated) mean, a winsorized mean, or an M-estimator using a Huber loss function or a Tukey bisquare loss function.

The processor 30 is further configured to determine the position of the device 10 based, at least in part, on the carrier phase smoothed estimate of the code phase. In particular, the carrier phase smoothed estimate of the code phase may be input into a Kalman filter, along with estimates of code phase measurements from other satellites of the SPS 1 to determine the location of the device 10.

The processor 30 may be configured to determine the median of the intermediate quantity using a min heap data structure 35 and a max heap data structure 40 stored in memory 31. Min heap data structures and max heap data structures are tree-based data structures that include multiple elements, or stored values. In a min heap data structure, parent elements are always less than or equal to those of child elements (such as child 37 and child 38, shown in FIG. 2) and the top of the binary tree (the root node) is always the element with the minimum value 36. In a max heap data structure, parent elements are always greater than or equal to those of child elements (such as child 42 and child 43, shown in FIG. 2) and the top of the binary tree (the root node) is always the element with the maximum value 41. While the min heap data structure 35 and the max heap data structure 40 are illustrated as a binary tree in FIG. 2, the actual data structure can be stored as an array in memory 31, as is known in the art. Multiple past intermediate quantities are stored in the min heap data structure and the max heap data structure according to the rules set out below. Each satellite of the SPS 1 stores intermediate quantities associated with past phase measurements in separate min and max heap data structures (not shown).

The processor 30 is configured to maintain the min heap data structure 35 and the max heap data structure 40 according to a set of rules. A first rule is that the minimum value 36 of the min heap 35 data structure is kept greater than or equal to a maximum value 41 of the max heap data structure 40. Thus, every time a new intermediate quantity, ƒ(t), is calculates, the intermediate quantity is compared to both the minimum value 36 and the maximum value 41 to determine into which heap the new intermediate quantity should be inserted. If the intermediate quantity is greater than the minimum value 36 of the min heap 35, the intermediate quantity is inserted into the min heap 35. If the intermediate quantity is less than the maximum value 41 of the max heap 40, the intermediate quantity is inserted into the max heap 40. Inserting new elements into a heap data structure requires a reorganization of the elements of the heap data structure. Techniques for reorganizing the elements of a heap are known in the art and may be referred to as heapsort, heapify or sifting.

A second rule that the processor 30 is configure to use to maintain the min heap data structure 35 and the max heap data structure 40 is that the number of values of the min heap data structure 35 may not differ from the number of values of the max heap data structure 40 by more than one. The number of values stored in a heap data structure is referred to as the size of the heap data structure. Thus, the min heap data structure 35 and the max heap data structure 40 are maintained by the processor 30 such that the size of the min heap data structure 35 is one less than the size of the max heap data structure 40, the size of the min heap data structure 35 is equal to the size of the max heap data structure 40, or the size of the min heap data structure 35 is one more than the size of the max heap data structure 40. To implement the second rule, the processor is configured to adjust the size of the two heaps after the new intermediate quantity is inserted into the min heap data structure 35 or the max heap data structure 40. The processor 30 compares the sizes of the two heaps and if the size of one of the heaps is more than one greater than the size of the other heap, then one value is removed from the larger heap and inserted into the other heap. For example, if the min heap data structure 35 has two more elements than the max heap data structure 40, then the minimum value 36 is removed from the min heap data structure 35 and inserted into the max heap data structure 40. Similarly, if the max heap data structure 40 has two more elements than the min heap data structure 35, then the maximum value 41 is removed from the max heap data structure 40 and inserted into the min heap data structure 35. As with inserting an element into a heap data structure, removing an element from a heap data structure requires a reorganization of the elements of the heap data structure. The same heapsorting techniques used after inserting a new element into a heap data structure can be used after removing an element from a heap data structure.

With the min heap data structure 35 and the max heap data structure 40 storing the past intermediate quantity of the signals from the satellite 15, the median value of the intermediate quantity can be determined quickly using only the min value 36 of the min heap data structure 35 and the max value 41 of the max heap data structure 40. The processor 30 is configured to determine the median value of the intermediate quantity in different ways depending on the relative sizes of the min heap data structure 35 and the max heap data structure 40. Thus, determining the median value of the intermediate quantity may include determining and comparing the number of values of each heap data structure. The processor 30 is configured to set the median value of the intermediate quantity equal to the maximum value of the max heap data structure in response to a determination that the number of values of the max heap data structure is larger than the number of values of the min heap data structure. The processor 30 is configured to set the median value of the intermediate quantity equal to the minimum value of the min heap data structure in response to a determination that the number of values of min heap data structure is larger than the number of values of the max heap data structure. The processor 30 is configured to set the median value of the intermediate quantity equal to a mean value of the maximum value of the max heap data structure and the minimum value of the min heap data structure in response to a determination that the number of values of the max heap data structure is equal to the number of values of the min heap data structure.

The processor 30 is configured to calculate the carrier-phase smoothed code-phase measurement using the median value of the intermediate quantity. For example, the processor 30 may add the most recent carrier phase measurement, φ(t), to the median value of the intermediate quantity.

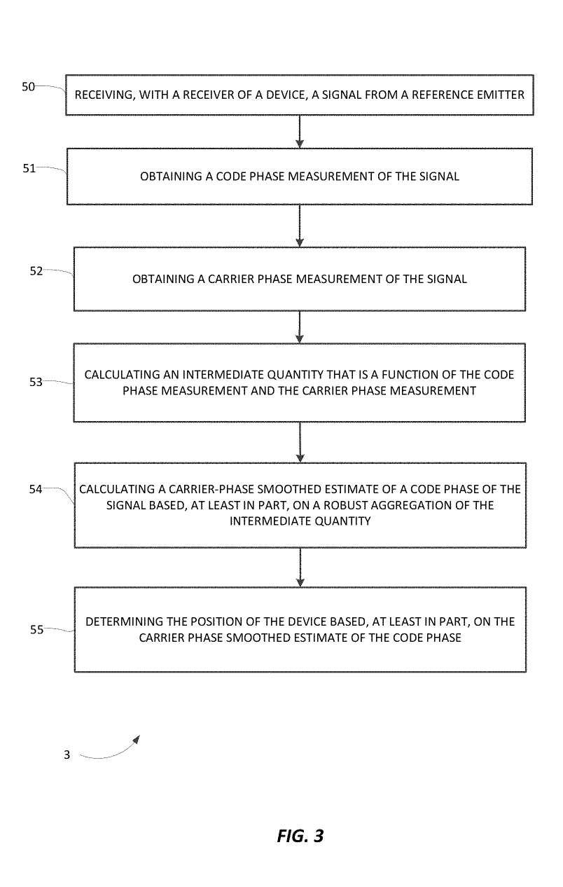

Referring to FIG. 3, with further reference to FIGS. 1-2, a method 3 of determining a position of a device 10 includes the stages shown. The method 3 is, however, an example only and not limiting. The method 3 can be altered, e.g., by having stages added, removed, rearranged, combined, performed concurrently, and/or having single stages split into multiple stages. For example, the method 3 may be performed iteratively at multiple times. For example, for each epoch of the SPS, the method 3 may be performed.

At stage 50, the method 3 includes receiving, with a receiver, a signal from a reference emitter. The receiver may be, for example, the SPS receiver 33 and the reference emitter may be satellite 15. The SPS receiver 33 may receive the signal 12 from the antenna 11. The SPS receiver 33 may process the signal 12 to determine a code phase measurement and a carrier phase measurement of the signal 12. The signal 12 and/or the code phase measurement and the carrier phase measurement may be sent to the processor 30 for additional processing. The measurements may be sent to the processor 30 directly, or sent to memory 31 for storage, from where the processor 30 may retrieve the measurements.

At stage 51, the method 3 includes obtaining a code phase measurement of the signal. The processor 30 may obtain the code phase measurement by receiving the measurement from the SPS receiver 33. Alternatively, the processor 30 may obtain the code phase measurement from memory 31 via bus 20. It is also possible for the processor 30 to receive the signal from the SPS receiver 33 such that the processor 30 performs the measurement of the code phase. The code phase measurement is a value related to the time required for the signal to propagate from satellite 15 to the device 10.

At stage 52, the method 3 includes obtaining a carrier phase measurement of the signal. The processor 30 may obtain the carrier phase measurement by receiving the measurement from the SPS receiver 33. Alternatively, the processor 30 may obtain the carrier phase measurement from memory 31 via bus 20. It is also possible for the processor 30 to receive the signal from the SPS receiver 33 such that the processor 30 performs the measurement of the carrier phase. The carrier phase measurement is a value related to the time required for the signal to propagate from satellite 15 to the device 10.

At stage 53, the method 3 includes calculating an intermediate quantity that is a function of the code phase measurement and the carrier phase measurement. For example, the processor 30 can calculate the intermediate quantity by subtracting the carrier phase measurement from the code phase measurement. The intermediate quantity can be stored in memory 31 along with past intermediate quantities calculated from previously received signals from the satellite 15. The intermediate quantities may be stored in two heap data structures, as described below. All past intermediate quantities may be stored in the memory 31. Alternatively, a limited number of previous intermediate quantities may be stored in the memory 31. For example, only the previous 10 intermediate quantities from time t, t−1, . . . , t−T′ may be stored in the memory 31, where t is the current time and T′ is the threshold number of intermediate quantities to be stored in the memory 31.

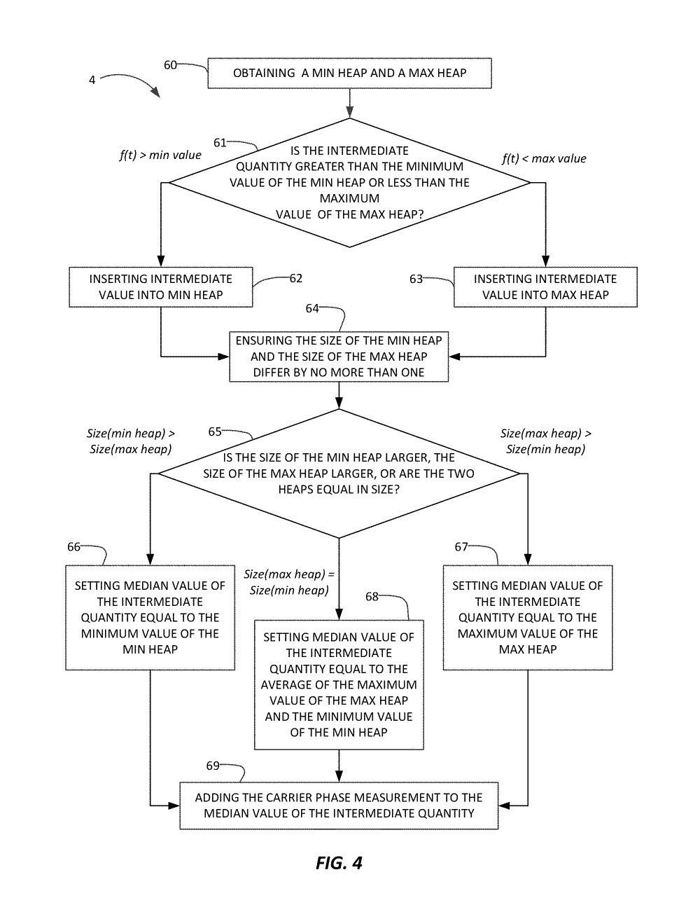

At stage 54, the method 3 includes calculating a carrier-phase smoothed estimate of a code phase of the signal 12 based, at least in part, on a robust aggregation of the intermediate quantity. The processor 30 can perform a robust aggregation technique on the intermediate quantity from the current time and the past intermediate quantities from previous times. Examples of robust aggregation techniques that may be used include a median, a trimmed (truncated) mean, a winsorized mean, or an M-estimator using a Huber loss function or a Tukey bisquare loss function. Details of an example technique for calculating a median value of the intermediate quantities is discussed below in connection with FIG. 4. Once the processor 30 determines the robust aggregation of the intermediate quantity, the processor 30 can determine the carrier carrier-phase smoothed estimate of a code phase of the signal 12 by adding the current carrier phase measurement to the robust aggregation.

At stage 55, the method 3 includes determining the position of the device based, at least in part, on the carrier-phase smoothed estimate of the code phase. The processor 30 may determine the position of the device using, for example, a Kalman filter and estimates of the code phase measurements from other satellites of the SPS 1.

Referring to FIG. 4, with further reference to FIGS. 1-3, a method 4 of calculating the carrier-phase smoothed estimate of the code phase is shown. The method 4 is, however, an example only and not limiting. The method 4 can be altered, e.g., by having stages added, removed, rearranged, combined, performed concurrently, and/or having single stages split into multiple stages. For example, the method 4 may be performed iteratively at multiple times. For example, for each epoch of the SPS, the method 3 may be performed. Also, the stage 54 of the method 3 may use the method 4 to calculate the carrier-phase smoothed estimate of the code phase.

At stage 60, the method 4 includes obtaining the min heap data structure 35 and the max heap data structure 40. The heap data structures can be stored in memory 31 as arrays, as is known in the art, and retrieved by the processor 30 via bus 20. If previous phase measurements have been made by the device, the heap data structures will already exist in memory 31. If the current time corresponds to the first phase measurement of a signal the processor may create the min heap data structure 35 and the max heap data structure 40.

At stage 61, the method 4 includes determining whether the current intermediate quantity, determined by the processor at the stage 53 of the method 3, is greater than the minimum value 36 of the min heap data structure 35 (i.e., the value stored in the root element of the min heap data structure 35) or less than the maximum value 41 of the max heap data structure 40 (i.e., the value stored in the root element of the max heap data structure 40). This determination may be performed by the processor 30. If it is determined that the intermediate quantity is greater than the minimum value 36 of the min heap data structure 35, then the method 4 continues to stage 62 where the intermediate quantity is inserted into the min heap data structure 35. If it is determined that the intermediate quantity is greater than less than the maximum value 41 of the max heap data structure 40, then the method 4 continues to stage 63 where the intermediate quantity is inserted into the max heap data structure 40. At stages 62 and 63, the insertion of the intermediate quantity into the heap data structure may include the processor 30 performing a reorganization of the heap data structure to ensure that every parent element of the max heap data structure 40 is greater than or equal to the corresponding children elements and ever parent element of the min heap data structure 35 is less than or equal to the corresponding children elements.

At stage 64, the method 4 includes ensuring, by the processor 30, that the size of the min heap data structure 35 and the size of the max heap data structure 40 differ by no more than one. The size of each heap data structure is defined as the number of values stored in the heap data structure. The processor 30 maintains the heaps such that neither one of the two heap data structures has more than one more element than the other heap data structure. To ensure the sizes of the two heap data structures differ by no more than one, the processor 30 may, after a new element is added to one of the heap data structures, compare the size of the size of the min heap data structure 35 and the size of the max heap data structure 40. If the min heap data structure 35 has two more elements than the max heap data structure 40, then the minimum value 36 is removed from the min heap data structure 35 and inserted into the max heap data structure 40. If the max heap data structure 40 has two more elements than the min heap data structure 35, then the maximum value 41 is removed from the max heap data structure 40 and inserted into the min heap data structure 35. After each removal and insertion of an element into the heap data structures, the processor 30 performs a reorganization of the heap data structures to ensure that every parent element of the max heap data structure 40 is greater than or equal to the corresponding children elements and ever parent element of the min heap data structure 35 is less than or equal to the corresponding children elements.

At stage 65, the method 4 includes determining which of the two heap data structures is larger in size, or if the sizes are equal. This determination is made by the processor 30 because the value for the median of the intermediate quantity is determined differently depending on the sizes of the two heap data structures. If the processor 30 determines that the size of the min heap data structure 35 is larger than the size of the max heap data structure 40, then the method 4 continues to stage 66 where the processor 30 sets the median value of the intermediate quantity equal to the minimum value 36 of the min heap data structure 35. If the processor 30 determines that the size of the max heap data structure 40 is larger than the size of the max heap data structure 35, then the method 4 continues to stage 67 where the processor sets the median value of the intermediate quantity equal to the maximum value 41 of the max heap data structure 40. If the processor 30 determines that the size of the max heap data structure 40 is equal to the size of the max heap data structure 35, then the method 4 continues to stage 68 where the processor sets the median value of the intermediate quantity equal to the average of the minimum value 36 of the min heap data structure 35 and the maximum value 41 of the max heap data structure 40.

At stage 69, the method 4 includes adding the carrier phase measurement to the median value of the intermediate quantity. This addition may be performed by the processor 30.

Other examples and implementations are within the scope and spirit of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Further, more than one invention may be disclosed.

A wireless network is a communication system in which communications are conveyed wirelessly, i.e., by electromagnetic and/or acoustic waves propagating through atmospheric space rather than through a wire or other physical connection. A wireless network may not have all communications transmitted wirelessly, but is configured to have at least some communications transmitted wirelessly.

Substantial variations to described configurations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions.

The processes, systems, and devices discussed above are examples. Various configurations may omit, substitute, or add various procedures or components as appropriate. For instance, in alternative configurations, the processes may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, some operations may be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform one or more of the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

What is claimed is:

1. A method of determining a position of a device, the method comprising:
receiving, with a receiver of the device, a signal from a reference emitter;
obtaining a code phase measurement of the signal;
obtaining a carrier phase measurement of the signal;
calculating an intermediate quantity that is a function of the code phase measurement and the carrier phase measurement;
calculating a carrier phase smoothed estimate of a code phase of the signal based, at least in part, on a robust aggregation of the intermediate quantity; and
determining the position of the device based, at least in part, on the carrier phase smoothed estimate of the code phase.

2. The method of claim 1, wherein the intermediate quantity comprises a difference between the code phase measurement and the carrier phase measurement.

3. The method of claim 2, wherein the robust aggregation of the intermediate quantity is a median value of the intermediate quantity.

4. The method of claim 3, wherein the method further comprises determining the median value of the intermediate quantity using a min heap data structure and a max heap data structure, wherein a minimum value of the min heap data structure is greater than or equal to a maximum value of the max heap data structure, and wherein a number of values of the min heap data structure and a number of values of the max heap data structure differs by no more than one.

5. The method of claim 4, wherein determining the median value of the intermediate quantity further comprises:
inserting the intermediate quantity into the min heap data structure in response to a determination that the intermediate quantity is greater than the minimum value of the min heap data structure; and
inserting the intermediate quantity into the max heap data structure in response to a determination that the intermediate quantity is less than the maximum value of the max heap data structure.

6. The method of claim 5, further comprising:
removing the minimum value from the min heap data structure and inserting the minimum value into the max heap data structure in response to a determination that the number of values of the min heap data structure is greater than the number of values of the max heap data structure by more than one; and
removing the maximum value from the max heap data structure and inserting the maximum value into the min heap data structure in response to a determination that the number of values of the max heap data structure is greater than the number of values of the min heap data structure by more than one.

7. The method of claim 6, further comprising:
setting the median value of the intermediate quantity equal to the maximum value of the max heap data structure in response to a determination that the number of values of the max heap data structure is greater than the number of values of the min heap data structure;
setting the median value of the intermediate quantity equal to the minimum value of the min heap data structure in response to a determination that the number of values of min heap data structure is greater than the number of values of the max heap data structure; and
setting the median value of the intermediate quantity equal to a mean value of the maximum value of the max heap data structure and the minimum value of the min heap data structure in response to a determination that the number of values of the max heap data structure is equal to the number of values of the min heap data structure.

8. The method of claim 1, wherein calculating the carrier phase smoothed estimate of the code phase of the signal comprises adding the carrier phase measurement to the robust aggregation of the intermediate quantity.

9. A device for determining a position of the device, the device comprising:
a wireless receiver for wirelessly receiving a signal from a reference emitter; and
a processor, communicatively coupled to the wireless receiver, configured to:
obtain a code phase measurement of the signal;
obtain a carrier phase measurement of the signal;
calculate an intermediate quantity that is a function of the code phase measurement and the carrier phase measurement;
calculate a carrier phase smoothed estimate of a code phase of the signal based, at least in part, on a robust aggregation of the intermediate quantity; and
determine the position of the device based, at least in part, on the carrier phase smoothed estimate of the code phase.

10. The device of claim 9, wherein the intermediate quantity comprises a difference between the code phase measurement and the carrier phase measurement.

11. The device of claim 10, wherein the processor is further configured to determine the robust aggregation of the intermediate quantity by determining a median value of the intermediate quantity

12. The device of claim 11, further comprising a memory configured to store a min heap data structure and a max heap data structure, and wherein the processor is further configured to determine the median value of the intermediate quantity using the min heap data structure and the max heap data structure, wherein a minimum value of the min heap data structure is greater than or equal to a maximum value of the max heap data structure, and wherein a number of values of the min heap data structure and a number of values of the max heap data structure differs by no more than one.

13. The device of claim 12, wherein the processor is further configured to determine the median value of the intermediate quantity by:
inserting the intermediate quantity into the min heap data structure in response to a determination that the intermediate quantity is greater than the minimum value of the min heap data structure; and
inserting the intermediate quantity into the max heap data structure in response to a determination that the intermediate quantity is less than the maximum value of the max heap data structure.

14. The device of claim 13, wherein the processor is further configured to:
remove the minimum value from the min heap data structure and insert the minimum value into the max heap data structure in response to a determination that the number of values of the min heap data structure is greater than the number of values of the max heap data structure by more than one; and
remove the maximum value from the max heap data structure and insert the maximum value into the min heap data structure in response to a determination that the number of values of the max heap data structure is greater than the number of values of the min heap data structure by more than one.

15. The device of claim 14, wherein the processor is further configured to:
set the median value of the intermediate quantity equal to the maximum value of the max heap data structure in response to a determination that the number of values of the max heap data structure is greater than the number of values of the min heap data structure;
set the median value of the intermediate quantity equal to the minimum value of the min heap data structure in response to a determination that the number of values of the min heap data structure is greater than the number of values of the max heap data structure; and
set the median value of the intermediate quantity equal to a mean value of the maximum value of the max heap data structure and the minimum value of the min heap data structure in response to a determination that the number of values of the max heap data structure is equal to the number of values of the min heap data structure.

16. The device of claim 9, wherein the processor is further configured to calculate the carrier phase smoothed estimate of the code phase of the signal by adding the carrier phase measurement to the robust aggregation of the intermediate quantity.

17. A device for determining a position of the device, the device comprising:
receiving means for wirelessly receiving a signal from a reference emitter;
first obtaining means for obtaining a code phase measurement of the signal;
second obtaining means for obtaining a carrier phase measurement of the signal;
calculating means for calculating an intermediate quantity that is a function of the code phase measurement and the carrier phase measurement;
smoothing means for calculating a carrier phase smoothed estimate of a code phase of the signal based, at least in part, on a robust aggregation of the intermediate quantity; and
positioning means for determining the position of the device based, at least in part, on the carrier phase smoothed estimate of the code phase.

18. The device of claim 17, wherein the intermediate quantity comprises a difference between the code phase measurement and the carrier phase measurement.

19. The device of claim 18, wherein the robust aggregation of the intermediate quantity is a median value of the intermediate quantity.

20. The device of claim 19, further comprising:
storing means for storing a min heap data structure and a max heap data structure; and
determining means for determining the median value of the intermediate quantity using the min heap data structure and the max heap data structure, wherein a minimum value of the min heap data structure is greater than or equal to a maximum value of the max heap data structure, and wherein a number of values of the min heap data structure and a number of values of the max heap data structure differs by no more than one.

21. The device of claim 20, wherein the determining means comprise:
first inserting means for inserting the intermediate quantity into the min heap data structure in response to a determination that the intermediate quantity is greater than the minimum value of the min heap data structure; and
second inserting means for inserting the intermediate quantity into the max heap data structure in response to a determination that the intermediate quantity is less than the maximum value of the max heap data structure.

22. The device of claim 21, wherein the determining means are further for:
removing the minimum value from the min heap data structure and inserting the minimum value into the max heap data structure in response to a determination that the number of values of the min heap data structure is greater than the number of values of the max heap data structure by more than one; and
removing the maximum value from the max heap data structure and inserting the maximum value into the min heap data structure in response to a determination that the number of values of the max heap data structure is greater than the number of values of the min heap data structure by more than one.

23. The device of claim 22, wherein the determining means are further for:
setting the median value of the intermediate quantity equal to the maximum value of the max heap data structure in response to a determination that the number of values of the max heap data structure is larger than the number of values of the min heap data structure;
setting the median value of the intermediate quantity equal to the minimum value of the min heap data structure in response to a determination that the number of values of min heap data structure is larger than the number of values of the max heap data structure; and
setting the median value of the intermediate quantity equal to a mean value of the maximum value of the max heap data structure and the minimum value of the min heap data structure in response to a determination that the number of values of the max heap data structure is equal to the number of values of the min heap data structure.

24. The device of claim 17, wherein the smoothing means are further for adding the carrier phase measurement to the robust aggregation of the intermediate quantity.

25. A non-transitory processor-readable storage medium comprising processor-readable instructions configured to cause a processor of a device to:
receive a signal from a reference emitter;
obtain a code phase measurement of the signal;
obtain a carrier phase measurement of the signal;
calculate an intermediate quantity that is a function of the code phase measurement and the carrier phase measurement;
calculate a carrier phase smoothed estimate of a code phase of the signal based, at least in part, on a robust aggregation of the intermediate quantity; and
determine the position of the device based, at least in part, on the carrier phase smoothed estimate of the code phase.

26. The non-transitory processor-readable storage medium of claim 25, wherein:
the intermediate quantity comprises a difference between the code phase measurement and the carrier phase measurement; and
the instructions configured to cause the processor to calculate the carrier phase smoothed estimate of the code phase of the signal include instructions configured to add the carrier phase measurement to the robust aggregation of the intermediate quantity.

27. The non-transitory processor-readable storage medium of claim 26, wherein the robust aggregation of the intermediate quantity is a median value of the intermediate quantity, and wherein the non-transitory processor-readable storage medium further comprises instructions configured to cause the processor to determine the median value of the intermediate quantity using a min heap data structure and a max heap data structure, wherein a minimum value of the min heap data structure is greater than or equal to a maximum value of the max heap data structure, and wherein a number of values of the min heap data structure and a number of values of the max heap data structure differs by no more than one.

28. The non-transitory processor-readable storage medium of claim 27, wherein the instructions configured to cause the processor to determine the median value of the intermediate quantity comprise instructions configured to cause the processor to:
insert the intermediate quantity into the min heap data structure in response to a determination that the intermediate quantity is greater than the minimum value of the min heap data structure; and
insert the intermediate quantity into the max heap data structure in response to a determination that the intermediate quantity is less than the maximum value of the max heap data structure.

29. The non-transitory processor-readable storage medium of claim 28, wherein the instructions configured to cause the processor to determine a median value of the intermediate quantity further comprise instructions configured to cause the processor to:
remove the minimum value from the min heap data structure and insert the minimum value into the max heap data structure in response to a determination that the number of values of the min heap data structure is greater than the number of values of the max heap data structure by more than one; and
remove the maximum value from the max heap data structure and insert the maximum value into the min heap data structure in response to a determination that the number of values of the max heap data structure is greater than the number of values of the min heap data structure by more than one.

30. The non-transitory processor-readable storage medium of claim 29, wherein the instructions configured to cause the processor to determine the median value of the intermediate quantity comprise instructions configured to cause the processor to:
set the median value of the intermediate quantity equal to the maximum value of the max heap data structure in response to a determination that the number of values of the max heap data structure is greater than the number of values of the min heap data structure;
set the median value of the intermediate quantity equal to the minimum value of the min heap data structure in response to a determination that the number of values of min heap data structure is greater than the number of values of the max heap data structure; and
set the median value of the intermediate quantity equal to the mean value of the maximum value of the max heap data structure and the minimum value of the min heap data structure in response to a determination that the number of values of the max heap data structure is equal to the number of values of the min heap data structure.
